(19) United States
(12) Patent Application Publication
(10) Pub. No.: US 2017/0161259 A1
(43) Pub. Date: Jun. 8, 2017

(54) Method and Electronic Device for Generating a Summary

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jiulong ZHAO, Beijing (CN)

(21) Appl. No.: 15/239,768

(22) Filed: Aug. 17, 2016

Related U.S. Application Data
(63) Continuation of application No. PCT/CN2016/088929, filed on Jul. 6, 2016.

(30) Foreign Application Priority Data
Dec. 3, 2015 (CN) 201510882825.5

(51) Int. Cl. G06F 17/27; G10L 15/08; G06F 17/24

(52) U.S. Cl. CPC G06F 17/2775; G06F 17/24; G10L 15/08

(57) ABSTRACT

Embodiments of the present disclosure provide a method and electronic device for generating a summary. The method includes: dividing a text to be processed into a plurality of sentence combinations, each of the sentence combinations includes a predetermined number of sentences; calculating weight values of all the sentences in each of the sentence combinations; selecting, for each of the sentence combinations, a sentence with a maximum weight value in the sentence combination as a candidate sentence; and combining a part of the candidate sentences corresponding to the sentence combinations into the summary of the text to be processed. According to the method provided by the present disclosure, a summary may be generated automatically according to a text content, which is convenient for readers to quickly obtain desired information by reading the summary, and may help readers to understand the essential of the text and to determine whether to read the text in details according to the essential of the text.

### CROSS-REFERENCE TO RELATED APPLICATION

This application is a continuation of international application No. PCT/CN2016/088929 filed on Jul. 6, 2016, and claims priority to a Chinese patent application No. 201510882825.5 filed with the State Intellectual Property Office of China on Dec. 3, 2015, both of which are incorporated herein by reference in their entireties.

### TECHNICAL FIELD

The present disclosure relates to computer technologies, and in particular, to a method and electronic device for generating a summary.

### BACKGROUND

With the popularization of Internet and the increase of information-acquiring approaches, large amount of information appear every day. Therefore, at present, a piece of news is generally presented with a news title, which is before the news text, and is a short text for summarizing or evaluating the news content, so as to divide, organize, disclose and evaluate the news content and attract readers.

However, since there is too much news data on the network at present, in order to attract users' attention and obtain more pageviews, some media may set exaggerated news titles, which are less related to the contents of an article. After reading such news, a user may not obtain desired information but just get his or her time and energy wasted.

### SUMMARY

The present disclosure provides a method and electronic device for generating a summary, so as to solve the technical problem of the prior art that a news title does not conform with a news content and a user may not obtain desired content by reading such news.

According to a first aspect of embodiments of the present disclosure, there provides a method for generating a summary, which includes: dividing a text to be processed into a plurality of sentence combinations, each of the sentence combinations includes a predetermined number of sentences; calculating weight values of all the sentences in each of the sentence combinations; selecting, for each of the sentence combinations, a sentence with a maximum weight value in the sentence combination as a candidate sentence; and combining a part of the candidate sentences corresponding to the sentence combinations into the summary of the text to be processed.

According to a second aspect of embodiments of the present disclosure, there provides a non-volatile computer-readable storage medium, which is stored with computer executable instructions that, when executed by an electronic device, cause the electronic device to: divide a text to be processed into a plurality of sentence combinations, each of the sentence combinations includes a predetermined number of sentences; calculate weight values of all the sentences in each of the sentence combinations; select, for each of the sentence combinations, a sentence with a maximum weight value in the sentence combination as a candidate sentence; and combine a part of the candidate sentences corresponding to the sentence combinations into the summary of the text to be processed.

According to a third aspect of embodiments of the present disclosure, there provides an electronic device including at least one processor and a memory communicably connected with the at least one processor and storing instructions executable by the at least one processor, wherein execution of the instructions by the at least one processor causes the at least one processor to: divide a text to be processed into a plurality of sentence combinations, each of the sentence combinations includes a predetermined number of sentences; calculate weight values of all the sentences in each of the sentence combinations; select, for each of the sentence combinations, a sentence with a maximum weight value in the sentence combination as a candidate sentence; and combine a part of the candidate sentences corresponding to the sentence combinations into the summary of the text to be processed.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for generating a summary according to an exemplary embodiment of the present disclosure;

FIG. 2 is a flow chart of step S102 in FIG. 1 in the present disclosure;

FIG. 3 is a flow chart of step S101 in FIG. 1 in the present disclosure;

FIG. 4 is a flow chart of step S104 in FIG. 1 in the present disclosure;

FIG. 5 is a flow chart of step S104 in FIG. 1 in the present disclosure; and

FIG. 6 is a diagram of a device for generating a summary according to an exemplary embodiment of the present disclosure.

### DETAILED DESCRIPTION

Exemplary embodiments, examples of which are shown in the drawings, will be illustrated in detail herein. When the description below is related to the drawings, same digitals in different drawings represent same or similar elements, unless expressed otherwise. The implementations described in the following exemplary embodiments do not represent all the implementations according to the present disclosure. Instead, they are only examples of the device and method according to some aspects of the present disclosure as described in detail in the claims appended.

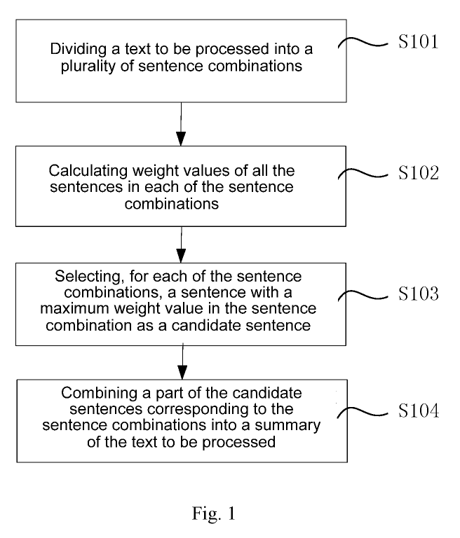

With the popularization of Internet and the increase of information-acquiring approaches, there appears tremendous amount of information every day. In order to quickly and accurately obtain useful information from such large amount of information, text automatic summarization processes become more and more important. Therefore, as shown in FIG. 1, in an embodiment of the present disclosure, there provides a method for generating a summary, which includes the following steps.

In step S101, a text to be processed is divided into a plurality of sentence combinations, each of the sentence combinations includes a predetermined number of sentences.

In this step, a text may be divided into a plurality of sentences according to a punctuation representing a long pause, such as a full stop, an exclamation mark and a question mark, etc., and a predetermined number of sentences may be combined into a sentence combination. In an embodiment of the present disclosure, a sentence combination may contain five sentences.

In step S102, weight values of all the sentences in each of the sentence combinations are calculated.

In this step, the weight of a sentence in the text to be processed may be calculated by using TextRank formula, and a similarity between two sentences may be calculated by using BM25 algorithm.

In step 103, for each of the sentence combinations, a sentence with a maximum weight value in the sentence combination is selected as a candidate sentence.

For example, if a sentence combination M contains 5 sentences A, B, C, D and E, and it is obtained that the sentence C has the maximum weight after the weights of the five sentences A, B, C, D and E in the text to be processed are calculated via TextRank formula, the sentence C may be selected as a candidate sentence. In a same way, if a sentence combination N contains 5 sentences F, G, H, I and J, the sentence F with the maximum weight may be selected as a candidate sentence. Similarly, in addition to the candidate sentences C and F, candidate sentences P, Q, R and S, etc., may be obtained.

In step S104, a part of the candidate sentences corresponding to the sentence combinations are combined into the summary of the text to be processed.

In this step, when the candidate sentences are C, F, P, Q, R and S, a predetermined number of candidate sentences with the maximum weights may be selected therefrom as the summary of the text to be processed, for example, CPQRS and CFPQS, etc.

In the present disclosure, a summary may be generated automatically according to a text content, which is convenient for a user to quickly obtain desired information by reading the summary, and may help readers to understand the essential of the text and to determine whether to read the original text in detail according to the essential of the text.

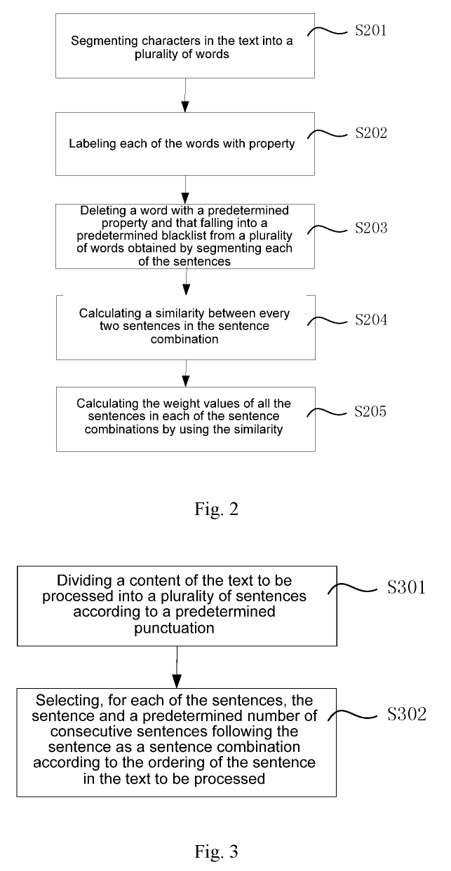

As shown in FIG. 2, in another embodiment of the present disclosure, the step S102 includes the following steps.

In step S201, characters in the text are segmented into a plurality of words.

In step S202, each of the words is labeled with property.

In steps S201 and S202, word segmenting may be performed on the text to be processed via a segmentation machine, so that entities, such as people's names and geographical names, etc., may be recognized, and words and properties thereof may be obtained.

In step S203, a word with a predetermined property and a word falling into a predetermined blacklist is deleted from a plurality of words obtained by segmenting each of the sentences;

In this step, a word with a predetermined property and a word in a predetermined blacklist may be filtered off according to the predetermined property and the predetermined blacklist. For example, when the predetermined properties of the words include names, names in the text to be processed may be deleted, and when the predetermined blacklist includes geographical names, geographical names in the text to be processed may be deleted, and the like.

In step S204, a similarity between every two sentences in the sentence combination is calculated.

In this step, the similarity between two sentences may be calculated via the following BM25 algorithm:

$$Score ( Q , d ) = {\sum }_{l}^{n} {W}_{l} \cdot R ( {q}_{i} , d )$$

In the embodiment of the present disclosure, Q and d represent two sentences, qi is a word in a sentence, Wi represents the weight of qi, R(qi, d) represents a relevance score between the semanteme qi and the text d to be processed, then Score(Q, d) represents the similarity between two sentences Q and d.

In step S205, the weight values of all the sentences in each of the sentence combinations are calculated by using the similarity.

In this step, the weight values of the sentences may be calculated via the following TextRank formula:

$$WS ( {V}_{i} ) = ( 1 - d ) + d * {\sum }_{{V}_{j} ∈ In ( {V}_{i} )} \frac{{w}_{ji}}{{\sum }_{{v}_{k} ∈ Out ( {V}_{j} )} {w}_{jk}} WS ( {V}_{j} )$$

Wherein, WS(Vi) on the left of the equation represents the weight of a sentence (WS is the abbreviation of weight_sum), the summation on the right represents the contribution of each of adjacent sentences to the current sentence, the numerator wji of the summation represents the similarity between two sentences, the denominator is another weight_sum, and WS(Vj) represents the weight of the last iteration j. In(vi) represents a node set directing to node vi, Out(vj) represents a node set to which the node vi directs, d represents a damping factor generally with a value of 0.85. The whole formula represents a iteration process.

In the method according to the embodiment of the present disclosure, each article can be regarded as a whole, relevance between sentences may be reflected, it is convenient for calculating the weight, the similarity between sentences can be compromised, and it may be avoided that a repeated sentence appears in the extracted summary.

As shown in FIG. 3, in another embodiment of the present disclosure, the sep S101 includes the following steps.

In step S301, a content of the text to be processed is divided into the plurality of sentences according to a predetermined punctuation.

In step S302, for each of the sentences, the sentence and a predetermined number of consecutive sentences following the sentence is selected as a sentence combination according to the ordering of the sentence in the text to be processed.

For example, if the text after being divided into a plurality of sentences includes sentences A, B, C, D, E, F and G, the sentences A, B, C, D and E may be taken as a first sentence combination, the sentences B, C, D, E and F may be taken as a second sentence combination, and the sentences C, D, E, F and G may be taken as a third sentence combination.

In the method according to the embodiment of the present disclosure, each sentence and the adjacent sentences thereof may be respectively combined into a sentence combination, thus the similarity and the weight value between the sentences may be calculated more accurately.

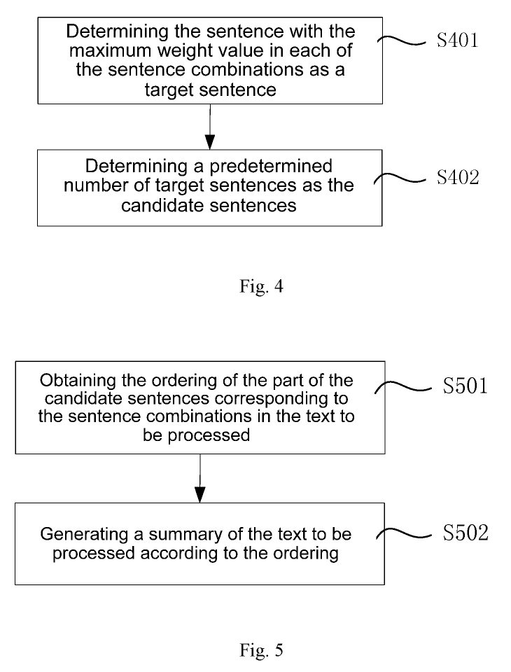

As shown in FIG. 4, in another embodiment of the present disclosure, the step S104 includes the following steps.

In step S401, a sentence with the maximum weight value in each of the sentence combinations is determined as a target sentence.

In step S402, a predetermined number of target sentences are determined as the candidate sentences.

In this step, after all the target sentences are ordered according to the weight values, a predetermined number of target sentences with the maximum weight value may be selected therefrom as candidate sentences.

In the embodiment of the present disclosure, “the most important” sentence, i.e., the sentence with the maximum weight value, in each sentence combination, may be determined as a target sentence, and after all the target sentences are ordered, “the most important” sentence is selected as a candidate sentence, thus the most important candidate sentence in the text may be selected accurately, so that a summary may be generated according to these candidate sentences. This has a small amount of calculation, and a comprehensive selection range.

As shown in FIG. 5, in another embodiment of the present disclosure, the step S104 includes the following steps.

In step S501, the ordering of the part of the candidate sentences corresponding to the sentence combinations in the text to be processed is obtained.

In this step, the locations of a part of the sentence combinations in the text or the sequencing thereof in the text may be obtained.

In step S502, the summary of the text to be processed is generated according to the ordering.

In this step, the summary of the text may be generated according to the sequencing of the part of the sentence combinations in the text.

In the method according to the embodiment of the present disclosure, the finally selected candidate sentences may be displayed according to the sequencing thereof in the text, thus it is convenient for a user to understand.

Additionally, an embodiment of the present disclosure further provides a computer storage medium which may be stored with programs that, when executed, cause a part or all of the steps in each of implementations of the method for generating a summary according to the embodiments shown in FIG. 1-FIG. 5 to be performed.

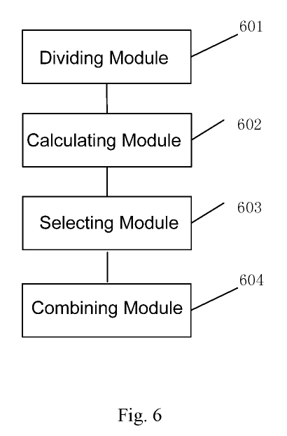

As shown in FIG. 6, in another embodiment of the present disclosure, there provides a device for generating a summary, which includes: a dividing module 601, a calculating module 602, a selecting module 603 and a combining module 604.

The dividing module 601 divides a text to be processed into a plurality of sentence combinations, each of the sentence combinations includes a predetermined number of sentences.

The calculating module 602 calculates weight values of all the sentences in each of the sentence combinations.

The selecting module 603 selects, for each of the sentence combinations, a sentence with a maximum weight value in the sentence combination as a candidate sentence.

The combining module 604 combines a part of the candidate sentences corresponding to the sentence combinations into the summary of the text to be processed.

In another embodiment of the present disclosure, the calculating module 602 includes a segmenting submodule, a labeling submodule, a deleting submodule, a similarity-calculating submodule and a weight-calculating submodule.

The segmenting submodule segments the characters in the text into a plurality of words.

The labeling submodule labels each of the words with property.

The deleting submodule deletes a word with a predetermined property and a word falling into a predetermined blacklist from a plurality of words obtained by segmenting each of the sentences.

The similarity-calculating submodule calculates a similarity between every two sentences in the sentence combination.

The weight-calculating submodule calculates the weight values of all the sentences in each of the sentence combinations by using the similarity.

In another embodiment of the present disclosure, the dividing module 601 includes a dividing submodule and a selecting submodule.

The dividing submodule divides a content of the text to be processed into a plurality of sentences according to a predetermined punctuation.

The selecting submodule selects, for each of the sentences, the sentence and a predetermined number of consecutive sentences following the sentence as a sentence combination according to the ordering of the sentence in the text to be processed.

In another embodiment of the present disclosure, the combining module 604 includes a first determining submodule and a second determining submodule.

The first determining submodule determines the sentence with the maximum weight value in each of the sentence combinations as a target sentence.

The second determining submodule determines a predetermined number of target sentences as the candidate sentences.

In another embodiment of the present disclosure, the combination module 604 includes an obtaining submodule and a generating submodule.

The obtaining submodule obtains the ordering of the part of the candidate sentences corresponding to the sentence combinations in the text to be processed.

The generating submodule generates the summary of the text to be processed according to the ordering.

Additionally, an embodiment of the present disclosure further provides an electronic device. The electronic device includes at least one processor and a memory communicably connected with the at least one processor and storing instructions executable by the at least one processor, wherein execution of the instructions by the at least one processor causes the at least one processor to: divide a text to be processed into a plurality of sentence combinations, each of the sentence combinations includes a predetermined number of sentences; calculate weight values of all the sentences in each of the sentence combinations; select, for each of the sentence combinations, a sentence with a maximum weight value in the sentence combination as a candidate sentence; and combine a part of the candidate sentences corresponding to the sentence combinations into the summary of the text to be processed.

In light of the description, one of ordinary skill in the art will readily envisage other embodiments of the present disclosure after practicing the present disclosure disclosed herein. The present application is intended to cover any modification, usage or adaptive variation of the present disclosure, which are based on general principles of the present disclosure and include common knowledge or conventional technical means in the art not disclosed in the present disclosure. The description and embodiments are merely deemed to be exemplary, and the scope and spirit of the present disclosure are to be defined by the following claims.

It should be understand that, the present disclosure is not limited to the particular structures described above and illustrated in figures, and may be modified and changed in various ways without departing from the scope thereof. The scope of the present disclosure is limited only by the appended claims.

1. A method for generating a summary, comprising:
dividing a text to be processed into a plurality of sentence combinations, each of the sentence combinations comprises a predetermined number of sentences;
calculating weight values of all the sentences in each of the sentence combinations;
selecting, for each of the sentence combinations, a sentence with a maximum weight value in the sentence combination as a candidate sentence; and
combining a part of the candidate sentences corresponding to the sentence combinations into the summary of the text to be processed.

2. The method for generating the summary according to claim 1, wherein, the calculating the weight values of all the sentences in each of the sentence combinations comprise:
segmenting characters in the text into a plurality of words;
labeling each of the words with property;
deleting a word with a predetermined property and a word falling into a predetermined blacklist from a plurality of words obtained by segmenting each of the sentences;
calculating a similarity between every two sentences in the sentence combination; and
calculating the weight values of all the sentences in each of the sentence combinations by using the similarity.

3. The method for generating the summary according to claim 1, wherein, the dividing the text to be processed into the plurality of sentence combinations comprises:
dividing a content of the text to be processed into the plurality of sentences according to a predetermined punctuation;
selecting, for each of the sentences, the sentence and a predetermined number of consecutive sentences following the sentence as a sentence combination according to the ordering of the sentence in the text to be processed.

4. The method for generating the summary according to claim 1, wherein, the combining a part of the candidate sentences corresponding to the sentence combinations into the summary of the text to be processed comprises:
determining the sentence with the maximum weight value in each of the sentence combinations as a target sentence; and
determining a predetermined number of target sentences as the candidate sentences.

5. The method for generating the summary according to claim 1, wherein, the combining a part of the candidate sentences corresponding to the sentence combinations into the summary of the text to be processed comprises:
obtaining the ordering of the part of the candidate sentences corresponding to the sentence combinations in the text to be processed;
in the summary of the text to be processed according to the ordering.

6-11. (canceled)

12. A non-volatile computer-readable storage medium, which is stored with computer executable instructions that, when executed by an electronic device, cause the electronic device to:
divide a text to be processed into a plurality of sentence combinations, each of the sentence combinations comprises a predetermined number of sentences;
calculate weight values of all the sentences in each of the sentence combinations;
select, for each of the sentence combinations, a sentence with a maximum weight value in the sentence combination as a candidate sentence; and
combine a part of the candidate sentences corresponding to the sentence combinations into the summary of the text to be processed.

13. The non-volatile computer-readable storage medium according to claim 12, wherein, the step to calculate the weight values of all the sentences in each of the sentence combinations comprises:
segmenting characters in the text into a plurality of words;
labeling each of the words with property;
deleting a word with a predetermined property and a word falling into a predetermined blacklist from a plurality of words obtained by segmenting each of the sentences;
calculating a similarity between every two sentences in the sentence combination; and
calculating the weight values of all the sentences in each of the sentence combinations by using the similarity.

14. The non-volatile computer-readable storage medium according to claim 12, wherein, the step to divide the text to be processed into the plurality of sentence combinations comprises:
dividing a content of the text to be processed into the plurality of sentences according to a predetermined punctuation;
selecting, for each of the sentences, the sentence and a predetermined number of consecutive sentences following the sentence as a sentence combination according to the ordering of the sentence in the text to be processed.

15. The non-volatile computer-readable storage medium according to claim 12, wherein, the step to combine a part of the candidate sentences corresponding to the sentence combinations into the summary of the text to be processed comprises:
determining the sentence with the maximum weight value in each of the sentence combinations as a target sentence; and
determining a predetermined number of target sentences as the candidate sentences.

16. The non-volatile computer-readable storage medium according to claim 12, wherein, the step to combine a part of the candidate sentences corresponding to the sentence combinations into the summary of the text to be processed comprises:
obtaining the ordering of the part of the candidate sentences corresponding to the sentence combinations in the text to be processed;
generating the summary of the text to be processed according to the ordering.

17. An electronic device, comprising:
at least one processor; and
a memory, communicably connected with the at least one processor and storing instructions executable by the at least one processor,
wherein execution of the instructions by the at least one processor causes the at least one processor to:
divide a text to be processed into a plurality of sentence combinations, each of the sentence combinations comprises a predetermined number of sentences;
calculate weight values of all the sentences in each of the sentence combinations;
select, for each of the sentence combinations, a sentence with a maximum weight value in the sentence combination as a candidate sentence; and
combine a part of the candidate sentences corresponding to the sentence combinations into the summary of the text to be processed.

18. The electronic device according to claim 17, wherein, the step to calculate the weight values of all the sentences in each of the sentence combinations comprises:
segmenting characters in the text into a plurality of words;
labeling each of the words with property;
deleting a word with a predetermined property and a word falling into a predetermined blacklist from a plurality of words obtained by segmenting each of the sentences;
calculating a similarity between every two sentences in the sentence combination; and
calculating the weight values of all the sentences in each of the sentence combinations by using the similarity.

19. The electronic device according to claim 17, wherein, the step to divide the text to be processed into the plurality of sentence combinations comprises:
dividing a content of the text to be processed into the plurality of sentences according to a predetermined punctuation;
selecting, for each of the sentences, the sentence and a predetermined number of consecutive sentences following the sentence as a sentence combination according to the ordering of the sentence in the text to be processed.

20. The electronic device according to claim 17, wherein, the step to combine a part of the candidate sentences corresponding to the sentence combinations into the summary of the text to be processed comprises:
determining the sentence with the maximum weight value in each of the sentence combinations as a target sentence; and
determining a predetermined number of target sentences as the candidate sentences.

21. The electronic device according to claim 17, wherein, the step to combine a part of the candidate sentences corresponding to the sentence combinations into the summary of the text to be processed comprises:
obtaining the ordering of the part of the candidate sentences corresponding to the sentence combinations in the text to be processed;
generating the summary of the text to be processed according to the ordering.
